(19) United States
(12) Patent Application Publication
(10) Pub. No.: US 2015/0378710 A1
(43) Pub. Date: Dec. 31, 2015

(54) Patching Auto-Stop

(71) Applicant: Microsoft Corporation, Redmond, WA (US)

(72) Inventors: Samuel Kabue, Seattle, WA (US); Shobana Krishnamoorthy, Redmond, WA (US); Jianfeng Cai, Redmond, WA (US); Roshane Silva, Seattle, WA (US)

(73) Assignee: MICROSOFT CORPORATION, Redmond, WA (US)

(21) Appl. No.: 14/318,582

(22) Filed: Jun. 28, 2014

(51) Int. Cl. G06F 9/445; G06F 9/44

(52) U.S. Cl. CPC G06F 8/65; G06F 8/70

(57) ABSTRACT

In one embodiment, a patch application system 330 for a server farm 310 may be programmatically integrated with a monitoring service 340 to allow for prompt reaction to a patching error. The patch application system 330 may implement a patch application 500 to a server farm 310. The patch application system 330 may receive an error notice 600 describing a patching error from a monitoring service 340. The patch application system 330 may automatically execute a response action to the patching error.

### BACKGROUND

A network service may allow multiple users to interact with data or an application via a data network. The data may be content on a website or a multi-share data file, accessible to be edited by multiple users. The application may be a software as a service application that a user purchases a yearly subscription to use. The user may use a client device to interact with the network service using a native application that interacts with the network service or a multi-purpose application, such as a web browser, that may retrieve the data. The network service may be maintained on the back end of a data connection from the client device by a set of servers, referred to as a server farm.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a patch application system for a server farm programmatically integrated with a monitoring service to allow for prompt reaction to a patching error. The patch application system may implement a patch application to a server farm. The patch application system may receive an error notice describing a patching error from a monitoring service. The patch application system may automatically execute a response action to the patching error.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a data network.

FIG. 2 illustrates, in a block diagram, one embodiment of a computing device.

FIG. 3 illustrates, in a block diagram, one embodiment of a network service update architecture.

FIG. 4 illustrates, in a block diagram, one embodiment of a server farm.

FIG. 5 illustrates, in a block diagram, one embodiment of a patch application.

FIG. 6 illustrates, in a block diagram, one embodiment of a patching error notice.

FIG. 7 illustrates, in a flowchart, one embodiment of a method for processing a patching error in the patch application system.

FIG. 8 illustrates, in a flowchart, one embodiment of a method for executing a response action in the patch application system.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a patch application system for a server farm.

A datacenter may maintain a server farm for operating a network service. When a potentially dangerous operation, like updating a version of the network service, runs in an automated fashion in the datacenter, the operation potentially may cause a detrimental effect on the quality of the service, from minor functionality loss, to critical functionality loss, to complete downtime. To combat this previously, a monitoring service may alert a human administrator when a patching error occurs to have that human administrator stop or roll back a patch application. A patch application is the addition of software code to a software system to update or correct a vulnerability or error in the software system. A patching error is a malfunction caused by the patch or occurs during the patch application.

By programmatically integrating a monitoring service with a patch application system, the patch application system may determine whether to proceed without human involvement. Before, during, and after a patch application on a server farm, the patch application system may reach out to the monitoring service and check for any open error notices. If no error notices are found, the patch application system may proceed through to completion. However if any such error notices are found, the patch application system may automatically pause on that server farm, again without any human involvement. Furthermore, with linear progression of patching server farms in a test server ring before proceeding to more exposed server rings, the entire progression may pause if a sufficiently severe patching error is discovered. The patch application system may automatically stop the operation before affecting paying customers. Additionally, a human administrator may mark the patching error as not being related to the patch application. The patch application system may then ignore that particular patching error while being vigilant for other errors.

Thus, in one embodiment, a patch application system for a server farm may be programmatically integrated with a monitoring service to allow for prompt reaction to a patching error. The patch application system may implement a patch application to a server farm. The patch application system may receive an error notice describing a patching error from a programmatically integrated monitoring service. The patch application system may automatically execute a response action to the patching error, such as pausing the patch application.

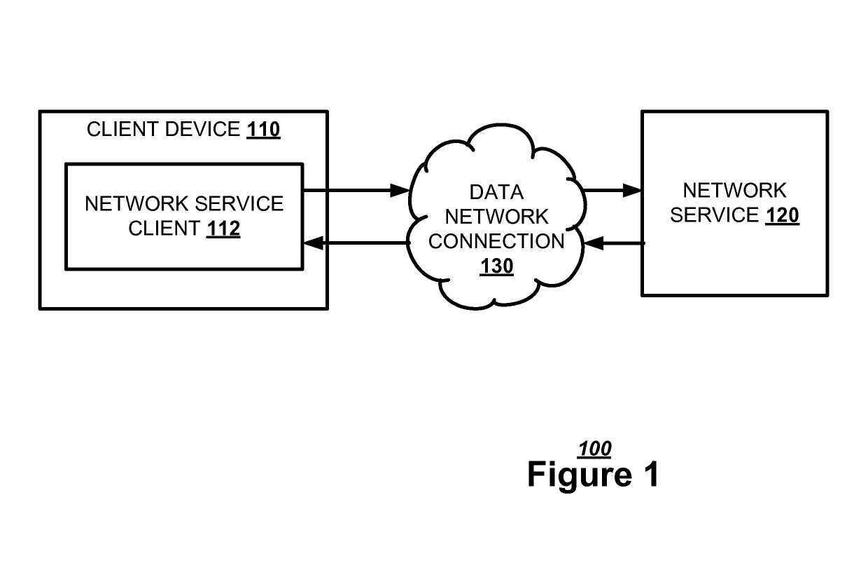

FIG. 1 illustrates, in a block diagram, one embodiment of a data network 100. A client device 110 may execute a network service client 112 to connect to a network service 120 via a data network connection 130. The network service client 112 may be a separate application or integrated into an operating system or an internet browser platform. The network service 120 may refer to a single server or a distributed set of servers that may access the cloud data set, such as a server farm. The data network connection 130 may be an internet connection, a wide area network connection, a local area network connection, or other type of data network connections. The network service client 112 may access data or an application maintained by the network service 120.

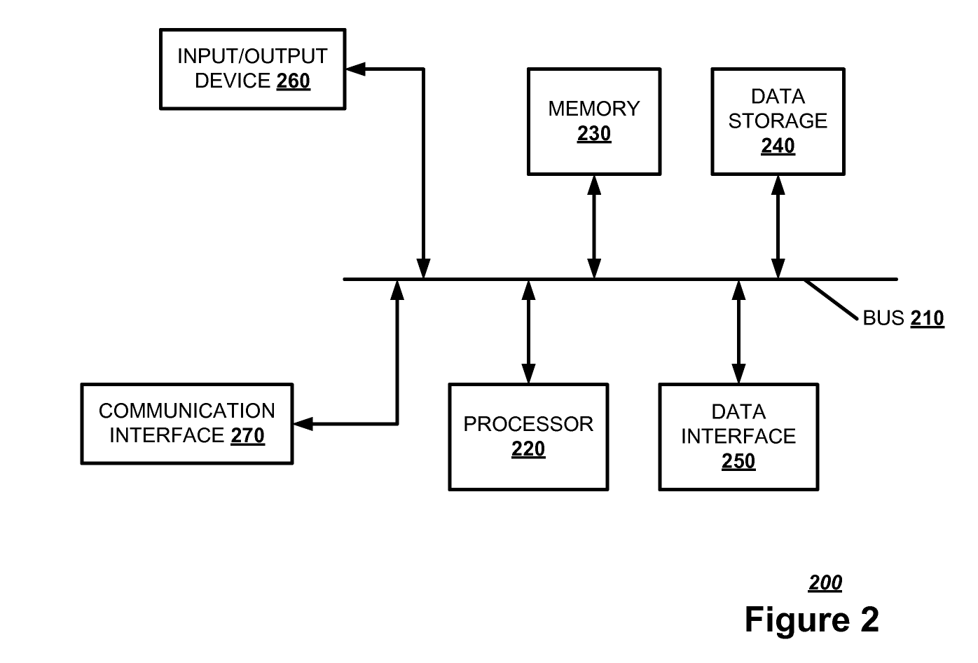

FIG. 2 illustrates a block diagram of an exemplary computing device 200 which may act as client device 110 or a server for implementing the network service 120. The computing device 200 may combine one or more of hardware, software, firmware, and system-on-a-chip technology to implement a client device 110 or a server for implementing the network service 120. The computing device 200 may include a bus 210, a processor 220, a memory 230, a data storage 240, a data interface 250, an input/output device 260, and a communication interface 270. The bus 210, or other component interconnection, may permit communication among the components of the computing device 200.

The processor 220 may include at least one conventional processor or microprocessor that interprets and executes a set of instructions. The memory 230 may be a random access memory (RAM) or another type of dynamic data storage that stores information and instructions for execution by the processor 220. The memory 230 may also store temporary variables or other intermediate information used during execution of instructions by the processor 220. The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing content or configuration data.

A data interface 250 may transmit data, patches, or software actions, such as calls, between the computing device 200 and other computing devices 200. The input/output device 260 may include one or more conventional mechanisms that permit a user to input information to the computing device 200, such as a keyboard, a mouse, a voice recognition device, a microphone, a headset, a gesture recognition device, a touch screen, etc. The input/output device 260 may include one or more conventional mechanisms that output information to the user, including a display, a printer, one or more speakers, a headset, or a medium, such as a memory, or a magnetic or optical disk and a corresponding disk drive. The communication interface 270 may include any transceiver-like mechanism that enables computing device 200 to communicate with other devices or networks. The communication interface 270 may include a network interface or a transceiver interface. The communication interface 270 may be a wireless, wired, or optical interface. The communication interface 270 may act as a data interface 250.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the data interface 250 or communication interface 270.

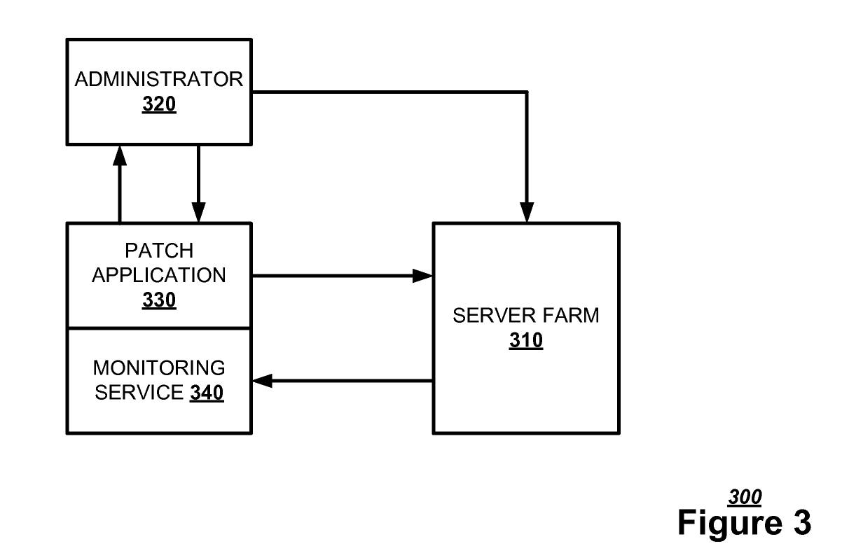

FIG. 3 illustrates, in a block diagram, one embodiment of a network service update architecture 300. The network service 120 may be maintained by a server farm 310. The server farm 310 may be a collection of servers that act to provide the network service to one or more users. A server farm 310 may support one or more network services 120.

An administrator 320 may update a server farm 310 by applying a patch to one or more servers in the server farm 310. A patch is a piece of software code added to a server application, possibly to add features, correct security vulnerabilities, or fix bugs. The administrator 320 may use a patch application system 330 to apply a patch to multiple servers in the server farm 310. The patch application system 330 may be a separate server that interacts with the other servers in the server farm 310 or an application that moves from server to server. The patch application system 330 may apply the patch sequentially, staged, or concurrently. A sequential application applies a patch to the server farm one server at a time. A concurrent application applies the patch to each server at the same time. A staged application applies the patch to the server farm 310 in groups of servers.

A monitoring service 340 may monitor the application of the patch to track performance and detect any patching error. A patching error is an application malfunction caused by the patch or the application of the patch. The monitoring service 340 may alert the patch application system 330 upon the detection of a patching error. The monitoring server 340 may be programmatically integrated with the patch application system 330, allowing the monitoring server 340 to directly interact with the patch application system 330. The monitoring server 340 may send an error notice about the patching error via a data communication or an application programming interface call.

Upon receiving an error notice describing the patching error from a monitoring service 340, the patch application system 330 may automatically execute a response action to the patching error. The patch application system 330 may pause the patch application in response to the patching error. The patch application system 330 may alert an administrator to the patch application being paused.

For minor or repeat patching errors, the monitoring service 340 may have a patch correction to allow self-healing. Alternately, the administrator 320 may develop the patch correction to fix the patching error. The monitoring service 340 or the administrator 320 may apply the patch correction. The patch application system 330 may check with the monitoring service 340 or the administrator 320 to determine if the patching error has been resolved. Alternately, the patch application system 330 may receive the patch correction from the administrator 320 or the monitoring service 340 so that the patch application system 330 may apply the patch correction. Once the patching error has been resolved, the patch application system 330 may resume the patch application.

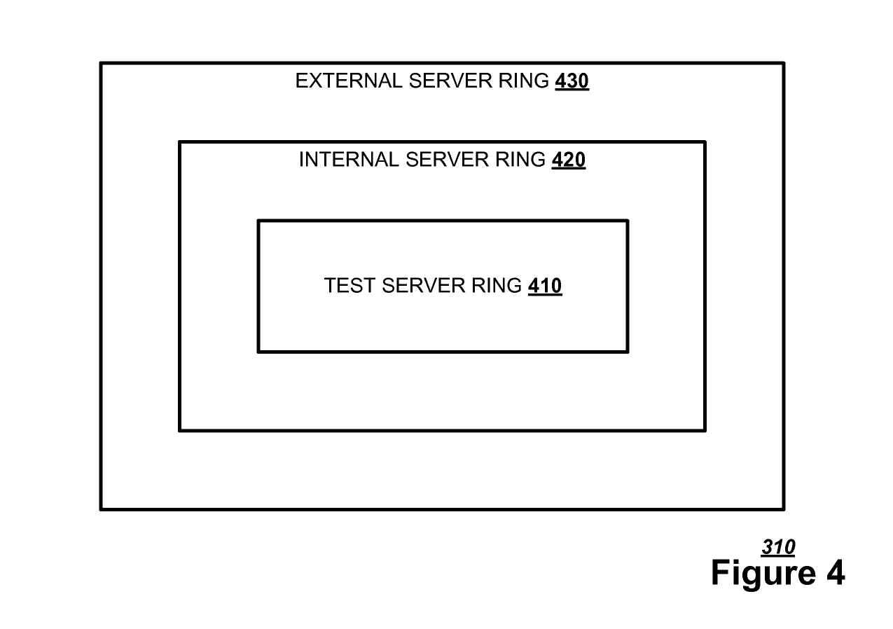

FIG. 4 illustrates, in a block diagram, one embodiment of a server farm 310. A server farm 310 may be divided into server rings. In a staged application, the patch application system 330 may execute a patch application on each server in a server ring before moving on to the next server ring. The server rings may be grouped by execution environment, function, or other grouping. For example, a test server ring 410 may be a group of servers configured to provide circumstances that cause a patching error. The test server ring 410 may be separated from the functional part of the server farm 310. By executing the patch application in this controlled environment first, the administrator 320 may identify any patching errors before executing the patch application to a server that may affect the user experience. An internal server ring 420 may be a group of servers that provide functionality that is invisible to an outside user. An external server ring 430 may have user facing functionality. The patch application system 330 may execute the patch application on the external server ring 430 last so that any patching errors are identified before being exposed to the user.

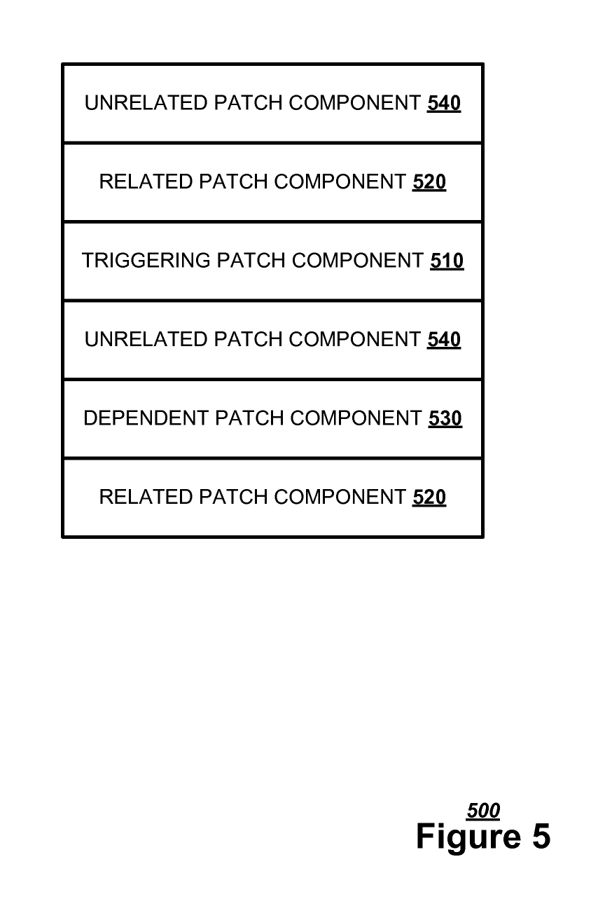

FIG. 5 illustrates, in a block diagram, one embodiment of a patch application 500. A patch application 500 may have one or more patch components. The monitoring service 340 may identify the patch component that causes the patching error, referred to here as a triggering patch component 510. A related patch component 520 is a patch component that is unable to function without the triggering patch component 510. A specific type of related patch component 520 may be a dependent patch component 530. A dependent patch component 530 is a patch component that receives a value or other object from the triggering patch component 510. An unrelated patch component 540 is a patch component that may be applied to a server application without applying the triggering patch component 510 and related patch components 520 while preserving functionality.

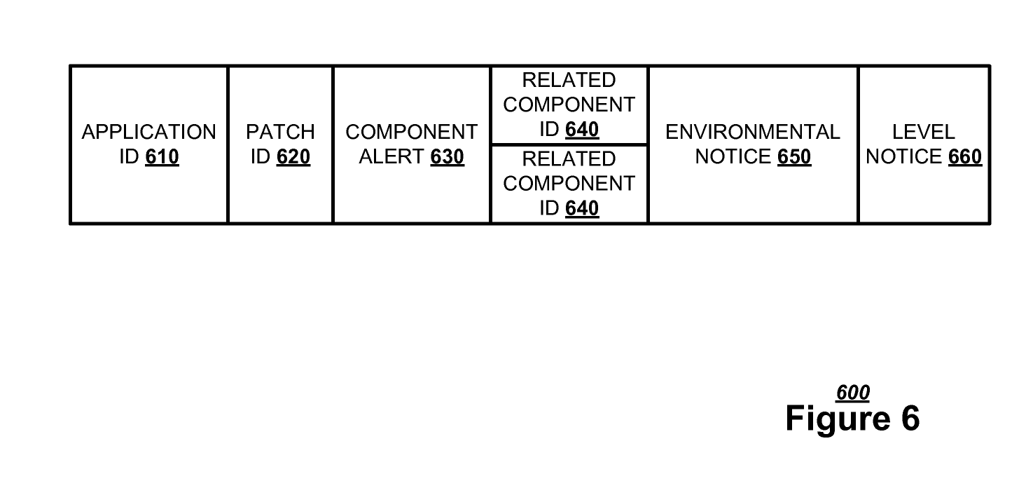

FIG. 6 illustrates, in a block diagram, one embodiment of an error notice 600. If the monitoring service 340 is programmatically integrated with the patch application system 330, with the patch application system 330 interlinked with the monitoring service 340, the error notice 600 may be an application programming interface call. Otherwise, the error notice 600 may be addressed with an application identifier (ID) 610. The error notice 600 may have a patch identifier 620 indicating the patch causing the error if multiple patches are being applied. The error notice 600 may have a component alert 630 indicating a triggering patch component 510 for the patching error. The error notice 600 may have a related component identifier 640 indicating a related patch component 520 related to the triggering patch component 510. Alternately, the patch application system 330 may determine a related patch component 520 or a dependent patch component 530. The error notice 600 may have an environmental notice 650 describing an execution environment for the patching error. The error notice 600 may have a level notice 660 describing a severity level for the patching error.

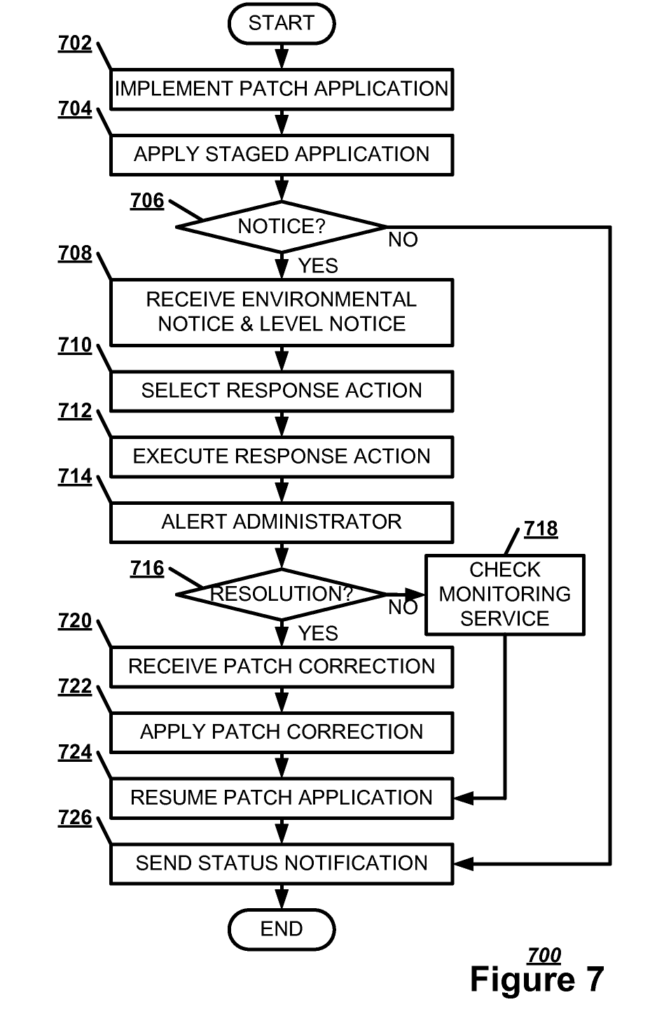

FIG. 7 illustrates, in a flowchart, one embodiment of a method 700 for processing a patching error in the patch application system 330. The patch application system 330 may implement a patch application 500 to a server farm 310 (Block 702). The patch application system 330 may apply the patch application 500 in a staged application (Block 704). If the patch application system 330 receives an error notice 600 describing a patching error from a programmatically integrated monitoring service 340 (Block 706), the patch application system 330 may receive at least one of an environmental notice 650 describing an execution environment for the patch error and a level notice 660 describing a severity level for the patching error from the programmatically integrated monitor service 340 (Block 708).

The patch application system 330 may select the response action based on at least one of the execution environment for the patching error and a severity level for the patching error (Block 710). For example, the patch application system 330 may ignore a patching error in an obscure execution environment or with low severity level. The patch application system 330 may execute automatically a response action to the patching error, such as pausing the patch application in response to the patching error (Block 712). The patch application system 330 may alert an administrator 320 to the patch application 500 being paused (Block 714).

If the patch application system 330 is not capable of resolving the patching error itself (Block 716), the patch application system 330 may check with the programmatically integrated monitoring service 340 to determine if the patching error has been resolved (Block 718). Otherwise, the patch application system 330 may receive a patch correction for the patching error from at least one of the administrator or the programmatically integrated monitoring service 340 (Block 720). The patch application system 330 may apply the patch correction to the patch application 500 (Block 722). The patch application system 330 may resume the patch application 500 upon resolution of the patching error (Block 724). The patch application system 330 may send a status notification upon applying a staged application to a server ring of the server farm 310 (Block 726).

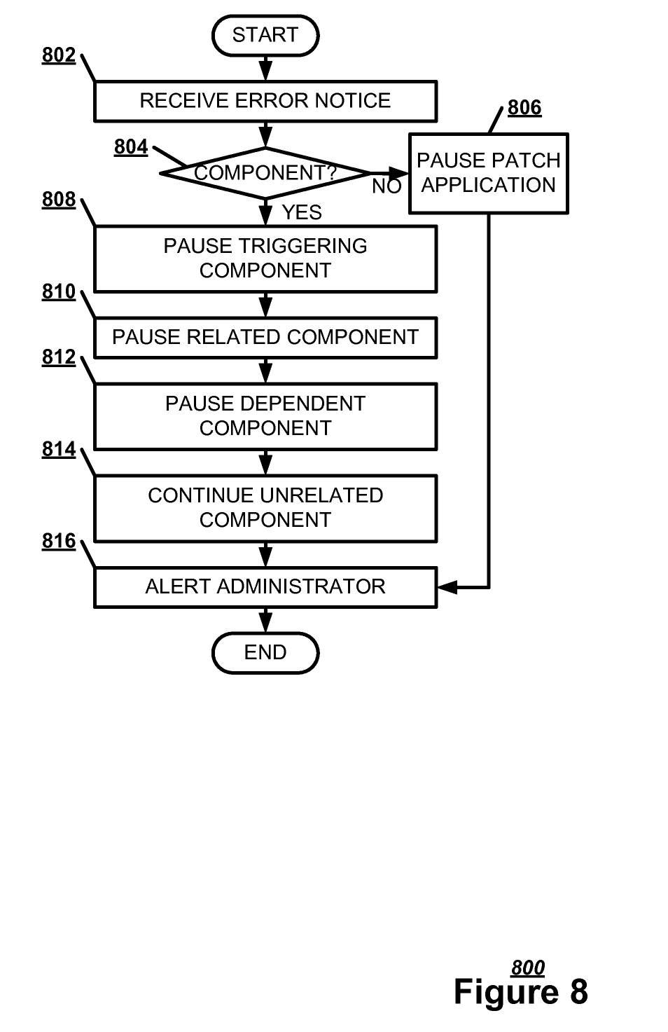

FIG. 8 illustrates, in a flowchart, one embodiment of a method 800 for executing a response action in the patch application system 330. The patch application system 330 may receive an error notice 600 describing a patching error from a programmatically integrated monitoring service 340 (Block 802). If the error notice 600 does not have a component alert (Block 804), the patch application system 330 may automatically pause the patch application 500 in response to the patching error (Block 806). If the patch application system 330 receives a component alert 630 indicating a triggering patch component 510 for the patching error (Block 804), the patch application system 330 may pause a triggering component application of a triggering patch component 510 for the patching error (Block 808). The patch application system 330 may pause a related component application of a related patch component 520 for a triggering patch component 510 (Block 810). The patch application system 330 may pause a dependent component application of a dependent patch component 530 for a triggering patch component 510 (Block 812). The patch application system 330 may continue an unrelated component application of an unrelated patch component 540 to a triggering patch component 510 (Block 814). The patch application system 330 may alert an administrator 320 to the patch application 500 being paused (Block 816).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

1. A machine-implemented method, comprising:
implementing a patch application to a server farm;
receiving an error notice describing a patching error from a programmatically integrated monitoring service; and
automatically pausing the patch application in response to the patching error.

2. The method of claim 1, further comprising:
alerting an administrator to the patch application being paused.

3. The method of claim 1, further comprising:
checking with the programmatically integrated monitoring service to determine if the patching error has been resolved.

4. The method of claim 1, further comprising:
resuming the patch application upon resolution of the patching error.

5. The method of claim 1, further comprising:
receiving a patch correction for the patching error from at least one of an administrator and the programmatically integrated monitoring service.

6. The method of claim 1, further comprising:
applying the patch application in a staged application.

7. The method of claim 1, further comprising:
sending a status notification upon applying a staged application to a server ring of the server farm.

8. A tangible machine-readable medium having a set of instructions detailing a method stored thereon that when executed by one or more processors cause the one or more processors to perform the method, the method comprising:
implementing a patch application to a server farm;
receiving an error notice describing a patching error from a programmatically integrated monitoring service; and
automatically executing a response action to the patching error.

9. The tangible machine-readable medium of claim 8, wherein the method further comprises:
pausing the patch application in response to the patching error.

10. The tangible machine-readable medium of claim 9, wherein the method further comprises:
alerting an administrator to the patch application being paused.

11. The tangible machine-readable medium of claim 8, wherein the method further comprises:
checking with the programmatically integrated monitoring service to determine if the patching error has been resolved.

12. The tangible machine-readable medium of claim 8, wherein the method further comprises:
resuming the patch application upon resolution of the patching error.

13. The tangible machine-readable medium of claim 8, wherein the method further comprises:
receiving a component alert indicating a triggering patch component for the patching error.

14. The tangible machine-readable medium of claim 8, wherein the method further comprises:
pausing a triggering component application of a triggering patch component for the patching error.

15. The tangible machine-readable medium of claim 8, wherein the method further comprises:
pausing at least one of a related component application of a related patch component and a dependent component application of a dependent patch component for a triggering patch component.

16. The tangible machine-readable medium of claim 8, wherein the method further comprises:
continuing an unrelated component application of an unrelated patch component to a triggering patch component.

17. The tangible machine-readable medium of claim 8, wherein the method further comprises:
receiving at least one of an environmental notice describing an execution environment for the patching error and a level notice describing a severity level for the patching error from the programmatically integrated monitor service.

18. The tangible machine-readable medium of claim 8, wherein the method further comprises:
selecting the response action based on at least one of an execution environment for the patching error and a severity level for the patching error.

19. A patch application system, comprising:
a data interface that receives an error notice describing a patching error for a patch application to a server farm from a programmatically integrated monitoring service; and
a processor that automatically pauses the patch application in response to the patching error.

20. The patch application system of claim 19, wherein the patch application resumes upon resolution of the patching error.
